(19) United States
(12) Patent Application Publication
(10) Pub. No.: US 2023/0082325 A1
(43) Pub. Date: Mar. 16, 2023

(54) UTTERANCE END DETECTION APPARATUS, CONTROL METHOD, AND NON-TRANSITORY STORAGE MEDIUM

(71) Applicant: NEC Corporation, Minato-ku, Tokyo (JP)

(72) Inventors: Shuji KOMEIJI, Tokyo (JP); Hitoshi YAMAMOTO, Tokyo (JP)

(73) Assignee: NEC Corporation, Minato-ku, Tokyo (JP)

(21) Appl. No.: 17/800,943

(22) PCT Filed: Feb. 26, 2020
(86) PCT No.: PCT/JP2020/007711

§ 371 Date: Aug. 19, 2022

(51) Int. Cl. G10L 25/78; G10L 15/26; G06F 40/20

(52) U.S. Cl. CPC G10L 25/78; G06F 40/20; G10L 15/26

(57) ABSTRACT

An utterance end detection apparatus (2000) acquires source data 10 representing an audio signal including one or more utterances. The utterance end detection apparatus (2000) converts the source data (10) into text data (30). The utterance end detection apparatus (2000) detects a conversion unit that analyzes text data (30), acquires source data, and converts the source data into text data, and an end of each utterance included in an audio signal represented by the source data (10).

### TECHNICAL FIELD

The present invention relates to speech recognition.

### BACKGROUND ART

A speech recognition technique has been developed. For example, an audio signal included in an utterance of a person is converted, based on speech recognition, into text data representing a content of the utterance.

Further, as one of techniques for improving accuracy of speech recognition, a technique for detecting a speech section (a section including an utterance) from an audio signal is known. In Patent Document 1, for example, a technique for detecting a speech section from an audio signal by using a learned model in which each of a feature of a start of a speech section, a feature of an end of a speech section, and a feature of another section is learned has been developed.

### Related Document

### Patent Document

Patent Document 1: Japanese Pat. Application Publication No. 2019-28446

### SUMMARY OF THE INVENTION

### Technical Problem

In speech section detection, an audio signal is divided into a speech section including an utterance and a speechless section not including an utterance. At that time, when there is substantially no breathing pause between utterances, a plurality of utterances may be included in one speech section. Therefore, in speech section detection, it is difficult to divide an audio signal including a plurality of utterances with respect to each utterance.

In view of the above-described problem, the present invention has been made. One of objects of the present invention is to provide a technique for detecting an end of each utterance from an audio signal including a plurality of utterances.

### Solution to Problem

An utterance end detection apparatus according to the present invention includes: 1) a conversion unit that acquires source data representing an audio signal including one or more utterances and, converts the source data into text data; and 2) a detection unit that analyzes the text data, and thereby detects an end of each utterance included in the audio signal.

A control method according to the present invention is executed by a computer. The control method includes: 1) a conversion step of acquiring source data representing an audio signal including one or more utterances, and converting the source data into text data; and 2) a detection step of analyzing the text data, and thereby detecting an end of each utterance included in the audio signal.

A program according to the present invention causes a computer to execute the control method according to the present invention.

### Advantageous Effects of Invention

According to the present invention, a technique for detecting an end of each utterance from an audio signal including a plurality of utterances is provided.

### BRIEF DESCRIPTION OF THE DRAWINGS

FIG. 1 is a diagram conceptually illustrating an operation of an end detection apparatus according to an example embodiment 1.

FIG. 2 is a block diagram illustrating a function configuration of the end detection apparatus.

FIG. 3 is a diagram illustrating a computer for achieving the end detection apparatus.

FIG. 4 is a flowchart illustrating a flow of processing executed by the end detection apparatus according to the example embodiment 1.

FIG. 5 is a diagram illustrating a word sequence including an end token.

FIG. 6 is a block diagram illustrating a function configuration of an utterance end detection apparatus including a recognition unit.

### DESCRIPTION OF EMBODIMENTS

Hereinafter, an example embodiment according to the present invention is described by using the accompanying drawings. Note that, in all drawings, a similar component is assigned with a similar reference sign and description thereof is omitted, as appropriate. Further, unless otherwise specifically described, in each block diagram, each block does not represent a configuration based on a hardware unit but represents a configuration based on a function unit. In the following description, unless otherwise specifically described, various predetermined values (a threshold and the like) is previously stored in a storage apparatus accessible from a function configuration unit using the value.

### Example Embodiment 1

### Outline

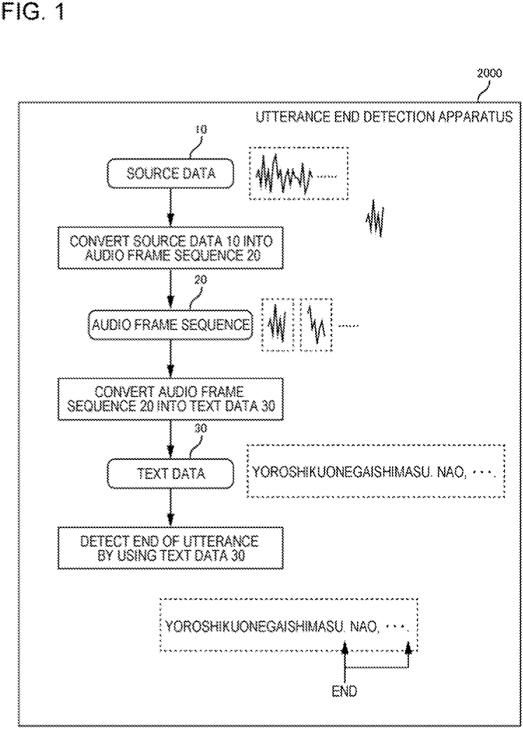

FIG. 1 is a diagram conceptually illustrating an operation of an end detection apparatus 2000 according to an example embodiment 1. Herein, an operation of the end detection apparatus 2000 to be described by using FIG. 1 is illustrative for easily understanding the end detection apparatus 2000 and does not limit an operation of the end detection apparatus 2000. Details and a variation of an operation of the end detection apparatus 2000 are described later.

The end detection apparatus 2000 is used for detecting an end of each utterance from an audio signal. Note that, an utterance referred to herein can be also reworded as a sentence. Therefore, the end detection apparatus 2000 operates as described below. The end detection apparatus 2000 acquires source data 10. The source data 10 are audio data in which an utterance of a person is recorded and are recorded data of, for example, a conversation and a speech, and the like. Audio data are, for example, vector data representing a waveform of an audio signal.

The end detection apparatus 2000 converts the source data 10 into text data 30. The text data 30 are, for example, a phoneme sequence or a word sequence. Then, the end detection apparatus 2000 analyzes the text data 30, and thereby detects an end of each utterance included in an audio signal (hereinafter, referred to as a source audio signal) represented by the source data 10.

Conversion from source data 10 into text data 30 is achieved, for example, by a method of converting the source data 10 into an audio frame sequence 20 and thereafter converting the audio frame sequence 20 into the text data 30. The audio frame sequence 20 is time-series data of a plurality of audio frames acquired from the source data 10. An audio frame is, in a source audio signal, for example, audio data representing an audio signal of a partial time section or an audio feature value acquired from the audio data. With regard to a time section relevant to each audio frame, a part of the time section may be overlapped or may not necessarily be overlapped with a time section relevant to another audio frame.

### One Example of Advantageous Effect

According to the end detection apparatus 2000, source data 10 are converted into text data 30 and the text data 30 are analyzed, and thereby an end of an utterance included in an audio signal represented by the source data 10 is detected. According to the end detection apparatus 2000, an end of each utterance is detected by analyzing text data in such a manner, and thereby an end of each utterance can be detected with high accuracy.

Hereinafter, the end detection apparatus 2000 is described in more detail.

### Example of Function Configuration

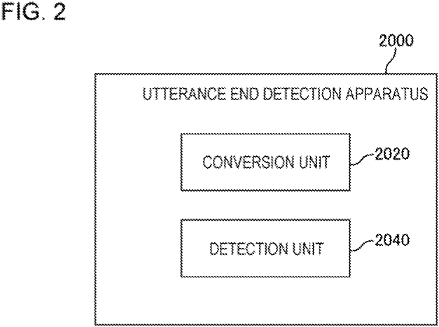

FIG. 2 is a block diagram illustrating a function configuration of the end detection apparatus 2000. The end detection apparatus 2000 includes a conversion unit 2020 and a detection unit 2040. The conversion unit 2020 converts source data 10 into text data 30. The detection unit 2040 detects, from the text data 30, an end of each of one or more utterances included in a source audio signal.

### Example of Hardware Configuration

Each function configuration unit of the end detection apparatus 2000 may be achieved by hardware (e.g., a hard-wired electronic circuit or the like) for achieving each function configuration unit, or may be achieved by a combination of hardware and software (e.g., a combination of an electronic circuit and a program controlling the electronic circuit, or the like). Hereinafter, a case where each function configuration unit of the end detection apparatus 2000 is achieved by a combination of hardware and software is further described.

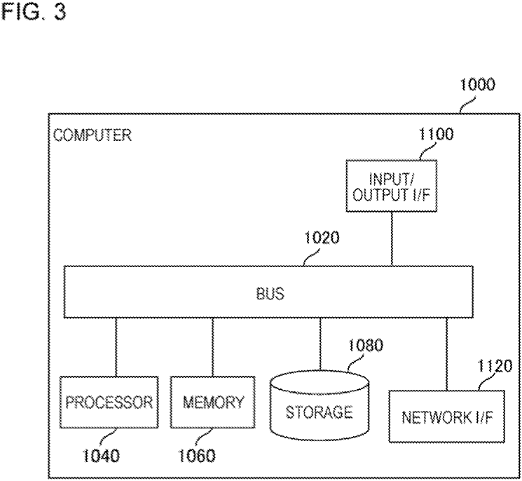

FIG. 3 is a diagram illustrating a computer 1000 for achieving the end detection apparatus 2000. The computer 1000 is any computer. The computer 1000 is, for example, a stationary computer such as a personal computer (PC) or a server machine. In another example, the computer 1000 is a portable computer such as a smartphone or a tablet terminal.

The computer 1000 may be a dedicated computer designed for achieving the end detection apparatus 2000, or may be a general-purpose computer. In the latter case, for example, a predetermined application is installed in the computer 1000, and thereby each function of the end detection apparatus 2000 is achieved by the computer 1000. The above-described application is configured by a program for achieving a function configuration unit of the end detection apparatus 2000.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and a network interface 1120 mutually transmit/receive data. However, a method of mutually connecting the processor 1040 and the like is not limited to bus connection.

The processor 1040 may be various types of processors such as a central processing unit (CPU), a graphics processing unit (GPU), and a field-programmable gate array (FPGA). The memory 1060 is a main storage apparatus achieved by using a random access memory (RAM) and the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. The input/output interface 1100 is connected to, for example, an input apparatus such as a keyboard and an output apparatus such as a display apparatus.

The network interface 1120 is an interface for connecting the computer 1000 to a communication network. The communication network is, for example, a local area network (LAN) or a wide area network (WAN).

The storage device 1080 stores a program (the above-described program for achieving the application) for achieving each function configuration unit of the end detection apparatus 2000. The processor 1040 reads the program onto the memory 1060 and executes the read program, and thereby achieves each function configuration unit of the end detection apparatus 2000.

Herein, the end detection apparatus 2000 may be achieved by one computer 1000, or may be achieved by a plurality of computers 1000. In the latter case, for example, the end detection apparatus 2000 is achieved as a distributed system including one or more computers 1000 for achieving the conversion unit 2020 and one or more computers 1000 for achieving the detection unit 2040,

### Flow of Processing

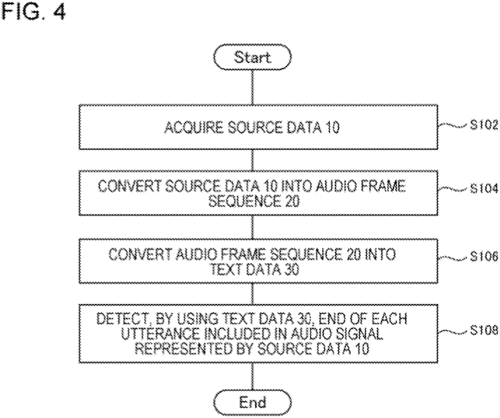

FIG. 4 is a flowchart illustrating a flow of processing executed by the end detection apparatus 2000 according to the example embodiment 1. The conversion unit 2020 acquires source data 10 (S102). The conversion unit 2020 converts the source data 10 into an audio frame sequence 20 (S104). The conversion unit 2020 converts the audio frame sequence 20 into text data 30 (S106). The detection unit 2040 detects, from the text data 30, an end of an utterance (S108).

### Acquisition of Source Data 10: S102

The conversion unit 2020 acquires source data 10 (S102). Any method of acquiring source data 10 by the conversion unit 2020 is employable. The conversion unit 2020 receives, for example, source data 10 transmitted from a user terminal operated by a user and acquires the source data 10. In addition, the conversion unit 2020 may acquire, for example, source data 10 stored in a storage apparatus accessible from the conversion unit 2020. In this case, for example, the end detection apparatus 2000 receives, from a user terminal, specification (specification of a file name or the like) of source data 10 to be acquired. In addition, the conversion unit 2020 may acquire, as source data 10, for example, each of one or more pieces of data stored in the above-described storage apparatus. In other words, in this case, batch processing is executed for a plurality of pieces of source data 10 previously stored in the storage apparatus.

### Conversion Into Audio Frame: S104

The conversion unit 2020 converts source data 10 into an audio frame sequence 20 (S104). Herein, an existing technique is usable as a technique for converting source data such as recorded data into an audio frame sequence 20. Processing of generating an audio frame is, for example, processing of extracting, while a time window having a predetermined length is moved from a head of a source audio signal with a fixed time width, an audio signal included in the time window in order. Each audio signal extracted in such a manner and a feature value acquired from the audio signal are used as an audio frame. Then, the extracted audio frame is arranged in time-series, and thereby an audio frame sequence 20 is formed.

### Conversion from Audio Frame Sequence 20 Into Text Data 30: S104

The conversion unit 2020 converts an audio frame sequence 20 into text data 30 (S104). Various methods of converting an audio frame sequence 20 into text data 30 are employable. It is assumed that, for example, a piece of text data 30 is a phoneme sequence. In this case, the conversion unit 2020 includes, for example, an acoustic model learned in such a way as to convert the audio frame sequence 20 into a phoneme sequence. The conversion unit 2020 inputs, in order, each audio frame included in the audio frame sequence 20 to the acoustic model. As a result, from the acoustic model, a phoneme sequence corresponding to the audio frame sequence 20 is acquired. Note that, an existing technique is usable as a technique for generating an acoustic model that converts an audio frame sequence into a phoneme sequence and a specific technique for converting an audio frame sequence into a phoneme sequence by using an acoustic model.

It is assumed that a piece of text data 30 is a word sequence. In this case, the conversion unit 2020 includes, for example, a conversion model (referred to as an end-to-end type speech recognition model) learned in such a way as to convert an audio frame sequence 20 into a word sequence. The conversion unit 2020 inputs, in order, each audio frame included in the audio frame sequence 20 into the conversion model. As a result, from the conversion model, a word sequence corresponding to the audio frame sequence 20 is acquired. Note that, an existing technique is usable as a technique for generating an end-to-end type model that converts an audio frame sequence into a word sequence.

### Detection of End: S108

The detection unit 2040 detects one or more ends of an utterance from text data 30 acquired by the conversion unit 2020 (S108). Herein, various methods of detecting an end of an utterance from text data 30 are employable. Hereinafter, some of the methods are exemplarily described.

### A Case Where a Piece of Text Data 30 is a Phoneme Sequence

The detection unit 2040 detects, for example, an end of an utterance by using a language model. The language model previously learns by using a plurality of pieces of training data including a pair of “a phoneme sequence, and a word sequence of a correct answer”. A phoneme sequence and a word sequence of a correct answer are generated based on the same audio signal. A phoneme sequence is generated, for example, by converting the audio signal into an audio frame sequence and converting the audio frame sequence into a phoneme sequence by using an acoustic model. A word sequence of a correct answer is generated, for example, by manual writing with respect to an utterance included in the audio signal.

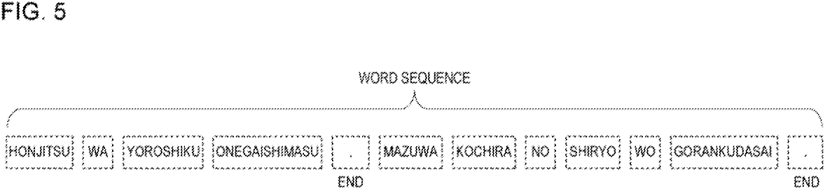

Herein, a word sequence of a correct answer includes, as one word, an end token (e.g., “.”) being a symbol or a character representing an end of an utterance. FIG. 5 is a diagram illustrating a word sequence including an end token. Each character sequence surrounded by a dotted line represents one word. A word sequence in FIG. 5 corresponds to a source audio signal including a first utterance being “Honjitsuwa... onegaishimasu” and a second utterance being “Mazuwa... gorankudasai”. Therefore, the word sequence in FIG. 5 includes, as one word, an end token being “.” at an end of each of the first utterance and the second utterance.

When a language model learned in such a manner is used, an audio frame sequence can be converted into a word sequence including an end token as in the word sequence illustrated in FIG. 5. Then, a portion where an end token is located in a word sequence can be detected as an end of an utterance. In FIG. 5, for example, each of two end tokens can be detected as an end of each of the first utterance and the second utterance.

Therefore, the detection unit 2040 inputs a phoneme sequence generated by the conversion unit 2020 to the above-described language model. As a result, a word sequence representing an end of each utterance as an end token can be acquired. The detection unit 2040 detects an end token from a word sequence acquired from a language model, and thereby detects an end of an utterance.

### A Case Where a Piece of Text Data 30 is a Word Sequence

The detection unit 2040 uses, for example, a list of words (hereinafter, referred to as an end word list) representing an end of an utterance. The end word list is previously generated and stored in a storage apparatus accessible from the detection unit 2040. The detection unit 2040 detects, from among words included in text data 30, a word matched with a word included in the end word list. Then, the detection unit 2040 detects the detected word as an end of an utterance.

Note that, matching referred to herein is not limited to complete matching, and may be backward matching. In other words, an end portion of a word included in text data 30 may be matched with any word included in the end word list. It is assumed that, for example, in the end word list, a word being “shimasu” (hereinafter, referred to as a word X) is included. In this case, not only when a word included in text data 30 is “shimasu” (when complete matching is made with the word X) but also when a word included in text data 30 is a word ending with “shimasu” such as “onegaishimasu” and “itashimasu” (when backward matching is made with the word X), it is determined that matching is made with the word X.

In addition, for example, a discrimination model that discriminates, in response to input of a word, whether the word is an end word may be previously prepared. In this case, the detection unit 2040 inputs each word included in text data 30 to the discrimination model. As a result, from the discrimination model, information (e.g., a flag) indicating whether the input word is an end word can be acquired.

A discrimination model previously learns in such a way as to be able to discriminate whether an input word is an end word. Learning is executed, for example, by using training data representing association being “a word, output of a correct answer”. When an associated word is an end word, output of a correct answer is information (e.g., a flag having a value of one) indicating that the associated word is an end word. On the other hand, when an associated word is not an end word, output of a correct answer is information (e.g., a flag having a value of zero) indicating that the associated word is not an end word.

### Method of Using Detection Result

As described above, the detection unit 2040 detects an end of an utterance represented by source data 10. Various methods of using information relating to a detected end are employable.

The end detection apparatus 2000 outputs, for example, information (hereinafter, referred to as end information) relating to an end detected by the detection unit 2040. The end information is, for example, information indicating to what portion of a source audio signal an end of each utterance is relevant. More specifically, end information indicates a time of each end as a relative time in which a head of a source audio signal is assumed to be a time 0.

In this case, the end detection apparatus 2000 needs to determine to what portion of a source audio signal an end word or an end token detected by the detection unit 2040 is relevant. In this point, an existing technique is usable as a technique for determining from what portion of an audio signal each word of a word sequence acquired from the audio signal is acquired. Therefore, in a case where an end of an utterance is detected by detecting an end word, the end detection apparatus 2000 uses such an existing technique and determines to what portion of a source audio signal an end word is relevant.

On the other hand, in a case where an end of an utterance is detected by using an end token, the end token itself does not appear in an audio signal. Therefore, the end detection apparatus 2000 determines, for example, to what portion of a source audio signal a word located immediately before an end token in a word sequence generated as text data 30 is relevant. Then, the end detection apparatus 2000 determines a time of a tail end of the determined portion as a time (i.e. a time of an end) relevant to the end token

Any output destination of end information is employable. The end detection apparatus 2000, for example, stores end information in a storage apparatus, displays end information on a display apparatus, or transmits end information to any other apparatus.

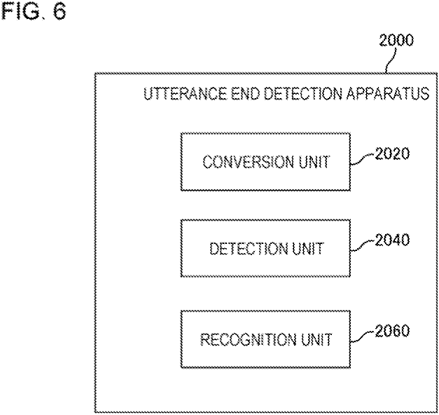

A method of using a detection result of an end is not limited to a method of outputting end information. The end detection apparatus 2000, for example, uses a detection result of an end for speech recognition. A function configuration unit that executes the speech recognition is referred to as a recognition unit. FIG. 6 is a block diagram illustrating a function configuration of the end detection apparatus 2000 including a recognition unit 2060.

In speech recognition, when an audio signal can be divided with respect to each utterance, recognition accuracy is improved. However, when there is an error in detection of an end of an utterance (for example, a geminate consonant is erroneously detected as an end of an utterance), an error occurs, when an audio signal is divided with respect to each utterance, in the divided position, and therefore recognition accuracy is decreased.

In this point, as described above, according to the end detection apparatus 2000, an end of an utterance can be detected with high accuracy. Therefore, based on an end of an utterance detected by the end detection apparatus 2000, source data 10 are divided with respect to each utterance and speech recognition processing is executed, and thereby highly-accurate speech recognition processing can be executed for source data 10.

The recognition unit 2060 determines, as a speechless section, for example, a period, in a source audio signal, from a time relevant to an end detected by the detection unit 2040 to a time at which after the former time, a sound having a predetermined level or more is detected. Further, the recognition unit 2060 also determines, as a speechless section, a period from a head of a source audio signal to a time at which after the former time, a sound having a predetermined level or more is detected. Further, the recognition unit 2060 eliminates, from the source data 10, speechless sections determined in such a manner. As a result, from the source data 10, one or more speech sections each representing one utterance are acquired. In other words, from a source audio signal, a speech section can be extracted based on an utterance unit. The recognition unit 2060 executes, by using any speech recognition algorithm, speech recognition processing for each speech section acquired in such a manner.

In particular, the end detection apparatus 2000 can accurately detect an end of an utterance, and therefore speech recognition using a backward algorithm can be achieved with high accuracy. Therefore, the recognition unit 2060 preferably uses, as an algorithm used for speech recognition processing, a backward algorithm or a pair of a forward algorithm and a backward algorithm. Note that, an existing method is usable as a specific method of speech recognition achieved by a backward algorithm or a pair of a forward algorithm and a backward algorithm.

Note that, the end detection apparatus 2000 converts, also in a process of detecting an end of an utterance, a source audio signal into a word sequence. In other words, speech recognition is executed for a source audio signal. However, this speech recognition is speech recognition executed while a source audio signal is not divided with respect to each utterance, and therefore is lower in recognition accuracy than speech recognition executed after a source audio signal is divided with respect to each utterance. Therefore, it is useful to execute speech recognition again after an audio signal is divided with respect to each utterance.

In other words, the end detection apparatus 2000 first executes speech recognition having accuracy to an extent that an end of an utterance can be detected for a source audio signal being not divided with respect to each utterance, and thereby detects an end of an utterance. Thereafter, the end detection apparatus 2000 executes speech recognition again for a source audio signal divided with respect to each utterance by using a detection result of an end, and thereby, finally achieves speech recognition with high accuracy.

### Selection of Model According to Usage Scene

Various types of models such as an acoustic model, a language model, an end-to-end type speech recognition model, or a discrimination mode used by the end detection apparatus 2000 is preferably switched according to a usage scene. For example, in a meeting for computer-field people, many technical terms in a computer field appear, but in a meeting for medical-field people, many technical terms in a medical field appear. Therefore, for example, a learned model is prepared for each field. In addition, a model is preferably prepared, for example, for each language such as Japanese and English.

As a method of selecting a model set with respect to each usage scene (a field or a language), various methods are employable. For example, in one end detection apparatus 2000, a model is set in such a way to be able to switch according to a usage scene. In this case, in a storage apparatus accessible from the end detection apparatus 2000, identification information of a usage scene and a learned model are previously stored in association with each other. The end detection apparatus 2000 provides a screen for selecting a usage scene to a user. The end detection apparatus 2000 reads, from the storage apparatus, a learned model relevant to a usage scene selected by a user. The conversion unit 2020 and the detection unit 2040 use the read model. Thereby, by using a learned model suitable for a usage scene selected by a user, detection of an end of an utterance is executed.

In addition, for example, a plurality of end detection apparatuses 2000 are prepared, and for each of end detection apparatuses 2000, models different from each other may be set. In this case, an end detection apparatus 2000 relevant to a usage scene is set to be used. For example, a front-end machine that receives a request from a user is prepared, and the machine is set to provide the above-described selection screen. When a user selects a usage scene on the selection screen, detection of an end of an utterance is executed by using an end detection apparatus 2000 relevant to the selected usage scene.

The whole or part of the example embodiments described above can be described as, but not limited to, the following supplementary notes.

1. An utterance end detection apparatus including:
a conversion unit that acquires source data representing an audio signal including one or more utterances, and converts the source data into text data; and
a detection unit that analyzes the text data, and thereby detects an end of each utterance included in the audio signal.

2. The utterance end detection apparatus according to supplementary note 1, wherein
a piece of the text data is a phoneme sequence,
the detection unit includes a language model that converts a phoneme sequence into a word sequence,
the language model is a model learned to convert a phoneme sequence into a word sequence including, as a word, an end token representing an end of an utterance, and
the detection unit
   inputs the text data to the language model, and thereby converts the text data into a word sequence, and
   detects, as an end of an utterance, the end token included in the word sequence.

3. The utterance end detection apparatus according to supplementary note 1, wherein
a piece of the text data is a word sequence, and
the detection unit detects a word representing an end of an utterance from the text data, and thereby detects an end of an utterance.

4. The utterance end detection apparatus according to any one of supplementary notes 1 to 3, further including

a recognition unit that divides, based on an end of an utterance detected by the detection unit, an audio signal represented by the source data into sections of utterances, and executes speech recognition processing for each of the sections.

5. The utterance end detection apparatus according to supplementary note 4, wherein

the recognition unit executes, for each of the sections, speech recognition processing using a backward algorithm.

6. A control method executed by a computer, including:
a conversion step of acquiring source data representing an audio signal including one or more utterances, and converting the source data into text data; and
a detection step of analyzing the text data, and thereby detecting an end of each utterance included in the audio signal.

7. The control method according to supplementary note 6, wherein
a piece of the text data is a phoneme sequence,
the control method further including,
in the detection step, including a language model that converts a phoneme sequence into a word sequence, wherein
the language model is a model learned to convert a phoneme sequence into a word sequence including, as a word, an end token representing an end of an utterance,
the control method further including:
in the detection step,
   inputting the text data to the language model, and thereby converting the text data into a word sequence; and
   detecting, as an end of an utterance, the end token included in the word sequence.

8. The control method according to supplementary note 6, wherein
a piece of the text data is a word sequence,
the control method further including,
in the detection step, detecting a word representing an end of an utterance from the text data, and thereby detecting an end of an utterance

9. The control method according to any one of supplementary notes 6 to 8, further including

a recognition step of dividing, based on an end of an utterance detected in the detection step, an audio signal represented by the source data into sections of utterances, and executing speech recognition processing for each of the sections.

10. The control method according to supplementary note 9, further including,

in the recognition step, executing, for each of the sections, speech recognition processing using a backward algorithm.

11. A program for causing a computer to execute the control method according to any one of supplementary notes 6 to 10.

### Reference Signs List

10 Source data
20 Audio frame sequence
30 Text data
1000 Computer
1020 Bus
1040 Processor
1060 Memory
1080 Storage device
1100 Input/output interface
1120 Network interface
2000 End detection apparatus
2020 Conversion unit
2040 Detection unit
2060 Recognition unit

What is claimed is:

Claim 1. An utterance end detection apparatus comprising:
at least one memory configured to store instructions: and
at least one processor configured to execute the instructions to perform operations comprising:
acquiring source data representing an audio signal including one or more utterances, and converting the source data into text data; and
analyzing the text data, and thereby detecting an end of each utterance included in the audio signal.

Claim 2. The utterance end detection apparatus according to claim 1, wherein
a piece of the text data is a phoneme sequence,
analyzing the text data comprises using a language model that converts a phoneme sequence into a word sequence,
the language model is a model learned to convert a phoneme sequence into a word sequence including, as a word, an end token representing an end of an utterance, and
analyzing the text data comprises inputting the text data to the language model, and thereby converting the text data into a word sequence, and
detecting an end of each utterance comprises detecting, as an end of an utterance, the end token included in the word sequence.

Claim 3. The utterance end detection apparatus according to claim 1, wherein
a piece of the text data is a word sequence, and
analyzing the text data comprises detecting a word representing an end of an utterance from the text data.

Claim 4. The utterance end detection apparatus according to claim 1, wherein the operations further comprise:
dividing, based on an end of an utterance detected by detecting an end of each utterance, an audio signal represented by the source data into sections of utterances; and
executing speech recognition processing for each of the sections.

Claim 5. The utterance end detection apparatus according to claim 4, wherein
executing speech recognition processing comprises executing, for each of the sections, speech recognition processing using a backward algorithm.

Claim 6. A control method executed by a computer, comprising:
acquiring source data representing an audio signal including one or more utterances, and converting the source data into text data; and
analyzing the text data, and thereby detecting an end of each utterance included in the audio signal.

Claim 7. A non-transitory storage medium storing a program for causing a computer to execute a control method, the control method comprising:
acquiring source data representing an audio signal including one or more utterances, and converting the source data into text data; and
analyzing the text data, and thereby detecting an end of each utterance included in the audio signal.

Claim 8. The control method according to claim 6, wherein
a piece of the text data is a phoneme sequence,
analyzing the text data comprises using a language model that converts a phoneme sequence into a word sequence,
the language model is a model learned to convert a phoneme sequence into a word sequence including, as a word, an end token representing an end of an utterance, and
analyzing the text data comprises inputting the text data to the language model, and thereby converting the text data into a word sequence, and
detecting an end of each utterance comprises detecting, as an end of an utterance, the end token included in the word sequence.

Claim 9. The control method according to claim 6, wherein
a piece of the text data is a word sequence, and
analyzing the text data comprises detecting a word representing an end of an utterance from the text data.

Claim 10. The control method according to claim 6, further comprising:
dividing, based on an end of an utterance detected by detecting an end of each utterance, an audio signal represented by the source data into sections of utterances; and
executing speech recognition processing for each of the sections.

Claim 11. The control method according to claim 10, wherein
executing speech recognition processing comprises executing, for each of the sections, speech recognition processing using a backward algorithm.

Claim 12. The non-transitory storage medium according to claim 7, wherein
a piece of the text data is a phoneme sequence,
analyzing the text data comprises using a language model that converts a phoneme sequence into a word sequence,
the language model is a model learned to convert a phoneme sequence into a word sequence including, as a word, an end token representing an end of an utterance, and
analyzing the text data comprises inputting the text data to the language model, and thereby converting the text data into a word sequence, and
detecting an end of each utterance comprises detecting, as an end of an utterance, the end token included in the word sequence.

Claim 13. The non-transitory storage medium according to claim 7, wherein
a piece of the text data is a word sequence, and
analyzing the text data comprises detecting a word representing an end of an utterance from the text data.

Claim 14. The non-transitory storage medium according to claim 7, wherein the control method further comprises:
dividing, based on an end of an utterance detected by detecting an end of each utterance, an audio signal represented by the source data into sections of utterances; and
executing speech recognition processing for each of the sections.

Claim 15. The non-transitory storage medium according to claim 14, wherein
executing speech recognition processing comprises executing, for each of the sections, speech recognition processing using a backward algorithm.
